(19) United States
(12) Patent Application Publication
(10) Pub. No.: US 2022/0259830 A1
(43) Pub. Date: Aug. 18, 2022

(54) MONITORING GROUND ENGAGING PRODUCTS FOR EARTH WORKING EQUIPMENT

(71) Applicant: ESCO GROUP LLC, Portland, OR (US)

(72) Inventor: Steven D. Hyde, Portland, OR (US)

(73) Assignee: ESCO Group LLC, Portland, OR (US)

(21) Appl. No.: 17/666,354

(22) Filed: Feb. 7, 2022

Related U.S. Application Data
(60) Provisional application No. 63/148,953, filed on Feb. 12, 2021.

(51) Int. Cl. E02F 9/26; E02F 9/28; G01M 5/00

(52) U.S. Cl. CPC E02F 9/26; E02F 9/2816; E02F 3/32; G01M 5/0033; E02F 9/2883

(57) ABSTRACT

A monitoring system located in a recess in a ground engaging product and secured to a base for monitoring a characteristic of the ground engaging product. The characteristic can pertain to presence, part ID, condition, usage and/or performance of ground-engaging product secured to the earth working equipment. The monitoring system may detect the presence and/or absence of one or more of the components of the ground engaging product.

### RELATED APPLICATIONS

This application claims priority benefits to U.S. Provisional Patent Application No. 63/148,953, filed Feb. 12, 2021, and entitled “MONITORING GROUND ENGAGING PRODUCTS FOR EARTH WORKING EQUIPMENT,” which is incorporated herein by reference in its entirety.

### FIELD OF THE DISCLOSURE

The present disclosure pertains to an assembly and system for monitoring ground-engaging products such as ground engaging tools and the like used on various kinds of earth working equipment.

### BACKGROUND OF THE DISCLOSURE

In earth working activities (e.g., mining and construction), ground engaging products are commonly provided on all kinds of earth working equipment to protect the underlying equipment from undue wear and, in some cases, also perform other functions such as breaking up and/or gathering the earthen material. Ground engaging products include, for example, teeth and shrouds that are secured to the digging edge of a bucket.

Heavy loading and abrasive conditions can cause ground engaging products to become separated from the earth working equipment. The operators of earth working equipment are not always able to see when a ground engaging product has separated. A separated ground engaging product may cause damage to downstream processing equipment. For example, if a separated ground engaging product is fed into a crusher, the product may be ejected and cause a hazard to workers, or it may become jammed and cause costly crusher downtime. A jammed crusher requires shutting down the machine and having an operator dislodge the part, which at times may be a difficult, time-consuming, and/or hazardous process. Additionally, continuing to operate the excavating equipment with missing ground engaging products can decrease overall productivity, and may cause the base, upon which the product was secured, to experience premature wear.

### SUMMARY OF THE DISCLOSURE

The present disclosure pertains to assemblies and systems for monitoring ground-engaging products for earth working equipment. The system can be used to monitor characteristics of ground-engaging products (such as presence, part identification, condition, performance, and/or usage of ground-engaging products) used on earth working equipment in mining, construction and other earth working operations.

In one example, a monitoring device is secured to an exterior surface of a base spaced from a boss over which a wear part is received and secured to monitor a characteristic of at least one component of the wear assembly.

In another example, the monitoring device is received into an opening defined in the wear part to receive a boss or other support received by the wear part when installed to monitor a characteristic of at least a component of the wear assembly.

In another example, a wear assembly for earth working equipment includes a base having a mounting portion with a boss or other support. A wear part includes an opening to receive the boss or other support of the base. A monitoring device is in the opening of the wear part. The monitoring device detects the presence and/or absence of the lock and/or wear part (and/or another characteristic(s)) and to wirelessly transmit a signal to indicate when the lock and/or wear part is absent from the base.

In another example, a wear assembly for earth working equipment includes a base having a mounting portion with a boss. A wear part includes at least one arm defining an opening in an inner surface to receive boss of the base. A lock hole is in the wear part to receive and position a lock in the opening with the boss. The lock is adjacent the boss to secure the wear part to the base. A monitoring device is in the opening of the wear part and secured to the base adjacent the lock when the lock is received in the lock hole. The monitoring device detects the presence and/or absence of the lock and to wirelessly transmit a signal to indicate when the lock is absent from the base.

In another example, a wear assembly for earth working equipment includes a base having a mounting portion and a boss. A wear part has a two arms defining a mounting cavity with an inner surface to receive the mounting portion, a lock hole, and an opening that aligns with the boss when the mounting portion is received into the channel. A lock is received in the lock hole in the wear part to be adjacent the boss and therein securing the wear part to the base. A monitoring device being free of movable components to detect the presence and/or absence of the wear part or lock, and to transmit a wireless signal when the wear part or lock is detected as absent.

In one other example, a wear assembly for earth working equipment includes a base having a mounting portion and a boss. A wear part having two arms defining a mounting cavity with an inner surface for receiving the mounting portion of the base. A lock secures the wear part to the base by being received in a lock hole. A proximity device is on the wear part and/or the lock. A monitoring device is in an opening in the wear part and secured to the base to detect the presence and/or absence of the proximity device, and to send a wireless signal when the proximity device is absent.

In another example, a wear assembly for earth working equipment includes a base having a mounting portion and a boss. A wear part has a two arms defining a mounting cavity with an inner surface to receive the mounting portion and boss of the base, a lock hole, and an opening that aligns with the boss when the mounting portion is received into the cavity. A lock is received in the lock hole in the wear part to be adjacent the boss and therein securing the wear part to the base. A monitoring device secured the base and within a hole in the wear part to detect a characteristic of the wear part and/or the base, the characteristic including at least one of presence, condition, usage, performance and/or part identification of the wear part and/or the base.

In another example, a monitoring system for monitoring a ground-engaging product secured to an earth working equipment includes a boss, a ground-engaging product having an exterior surface subject to wear during use, an interior surface with an opening, and a lock hole for receiving a lock to secure the ground-engaging product to the equipment. A monitoring device is within the opening in the ground-engaging product to monitor a characteristic of the ground-engaging product. The monitoring device including a sensor and a communication device for wirelessly transmitting information from the sensor.

In another example, a wear assembly for earth working equipment includes a digging edge with a monitoring device secured to a surface of the digging edge. A wear part having a cavity for receiving the digging edge, a lock hole, and an opening. A lock is received in the lock hole to secure the wear part to the digging edge. The monitoring device is received into the opening of the wear part to detect when the wear part has separated from the digging edge and to transmit a wireless signal. The wireless signal may be a continuous signal, a signal only when the wear part has separated, or a different signal once separation has occurred.

In another example, a monitoring system for monitoring a ground-engaging product secured to an earth working equipment includes a Hall effect sensor in an opening in the ground-engaging product for identifying whether the product has separated from the base, and a communication device for wirelessly communicating information about the presence and/or absence of the ground-engaging product.

In one other example, a system may include a monitoring device associated with a wear part, a base, at least one remote device to cooperate with the monitoring device, and a programmable logic device to process the information communicated between the devices. The programmable logic device uses the information to determine characteristics of the wear part including one or more of part identification, presence, performance and/or usage of the ground engaging product attached to the earth working equipment.

In another example, the monitoring system may include a proximity device(s) secured to a lock and/or wear part, and a sensor secured to a base and received in an opening of the wear part.

In another example, a monitoring device is secured to a base received within an opening in a wear part, proximate but separate from a lock hole where a lock secures the wear part to the earth working equipment, to detect a characteristic of the wear part, such as the presence and/or loss of the lock.

In another example, a monitoring system for earth working equipment includes a base of the earth working equipment, a wear part on the base, a lock securing the wear part to the base, and a monitoring device. The base includes at least one side over which earthen material commonly passes during use of the earth working equipment, and a boss on the side. The wear part includes a recess to receive the boss. The monitoring device is secured to the at least one side of the base in the recess between the wear part and the base. The monitoring device includes at least one sensor to monitor at least one characteristic of the wear part and a communication device to send a wireless signal regarding the at least one characteristic to a remote device.

In another example, a monitoring system for earth working equipment includes a wear part, a lock and a monitoring device. The wear part has a mounting cavity to receive a base, a recess open to the mounting cavity to receive a boss on the base, and a lock opening that opens in the recess. The lock is in the lock opening and in the recess adjacent the boss to secure the wear part to the base. The monitoring device is received in the recess and secured to a side of the base to monitor at least one characteristic of the wear part. In another example, a monitoring system for earth working equipment includes a base, a wear part, a lock and a monitoring device. The base is secured to the earth working equipment and includes a boss.

The wear part includes at least one arm having a recess to receive the boss and a lock opening that communicates with the recess. The lock is received in the lock opening in the wear part to secure the wear part to the base. The monitoring device is secured to the base and received in the recess adjacent the lock. The monitoring device detects the presence and/or absence of the lock and/or the wear part, and wirelessly transmits a signal to indicate when the lock and/or the wear part is absent from the base.

### BRIEF DESCRIPTION OF THE DRAWINGS

FIG. 1 is a side view of a mining excavator.

FIG. 2 is a perspective view of an exemplary bucket.

FIG. 3 is a perspective view of a lip of the bucket of FIG. 2 with two upper and one lower wing shroud assemblies.

FIG. 4 is a perspective view of one of the upper wing shroud assemblies shown in FIG. 3.

FIG. 5 is a rear perspective view of the upper wing shroud of FIG. 4.

FIG. 6A is an exploded perspective view of one of the wing shroud assembly of FIG. 3.

FIG. 6B is an exploded perspective view of a second shroud assembly.

FIG. 7A is a cross-sectional view taken along line 7A-7A in FIG. 3, showing a first example of a monitoring system according to the present disclosure.

FIG. 7B is a cross-sectional view of the second shroud assembly of FIG. 6B.

FIG. 8 is a perspective view of a monitoring device.

FIG. 9 is an exploded view of the monitoring device of FIG. 8.

FIG. 10 is a side view of a service truck and a bucket.

FIG. 11 is a perspective view of bucket and a handheld remote device.

### DETAILED DESCRIPTION OF PREFERRED EXAMPLES

The present disclosure pertains to assemblies and systems for monitoring characteristics of ground-engaging wear parts for use on earth working equipment. The monitored characteristics may include, for example, presence, part identification, condition, performance and/or usage of ground-engaging products on the earth working equipment. As examples, the devices and systems can be used to monitor ground-engaging products secured to dozers, loaders, dragline machines, cable shovels, face shovels, hydraulic excavators, dredge cutters, buckets, lips, rippers, shear drums, continuous miners, crushers, etc. Examples of wear parts for such ground-engaging products include points, base adapters, intermediate adapters, shrouds, upper and lower wing shrouds, runners, picks, wear plates, tips, etc. Some of the example wear parts (e.g., base adapters or intermediate adapters) can also be considered a base because they in turn support other components.

Relative terms such as front, rear, top, bottom and the like are used for convenience of discussion. The terms front or forward are generally used to indicate the usual direction of travel of the ground engaging product relative to the earthen material during use (e.g., while digging), and upper or top are generally used as a reference to the surface over which the material generally passes when, for example, it is gathered into a bucket. Nevertheless, in the operation of various earth working equipment, the ground engaging products may be oriented in various ways and move in all kinds of directions during use.

For ease of discussion, the monitoring of ground engaging products secured to an excavating bucket is generally discussed herein, and in particular the monitoring of specific kinds of shrouds. However, the monitoring systems of the present disclosure could be used to monitor other kinds of ground engaging products on various types of earth working equipment. As examples only, the monitoring system may monitor a point on an adapter (intermediate or base), an intermediate adapter on a base adapter or integral cast nose, a wear runner on a bucket, teeth on a dredge cutter head, picks on a shearer drum, liners on a chute or truck tray, tips in a roll crusher, and the like. The ground engaging products may be attached to various equipment and may be secured in various ways (e.g., using various mechanical attachments including different locks and the like).

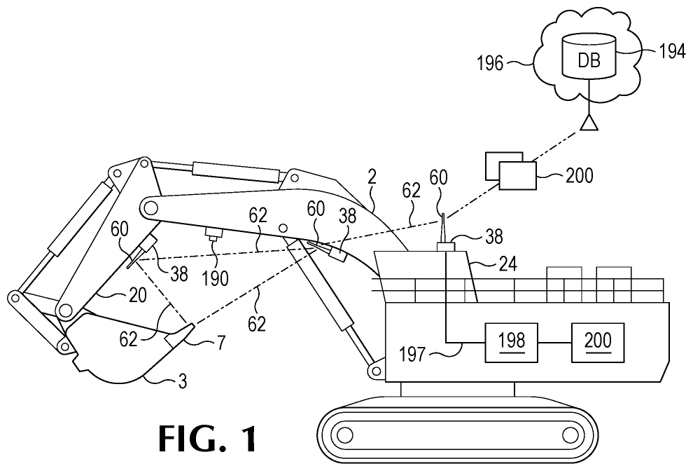

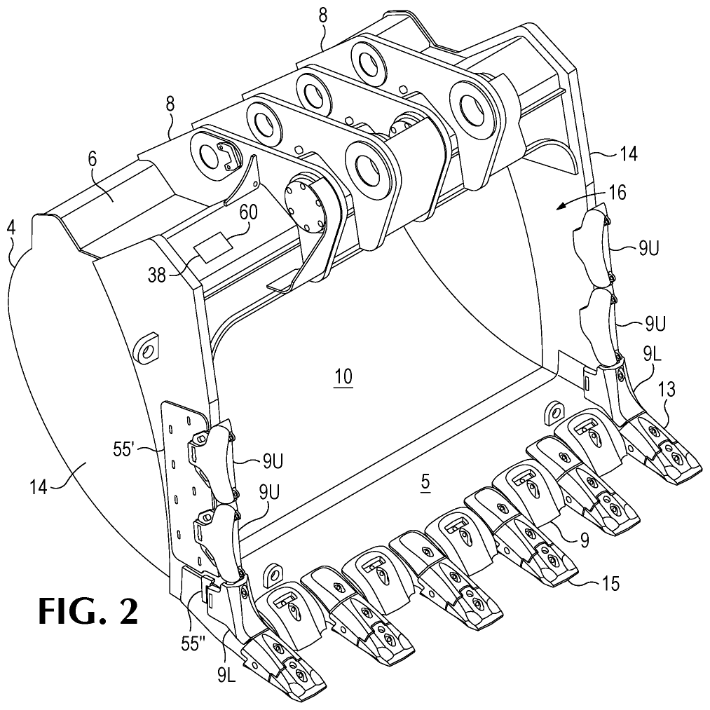

Referring to FIGS. 1-2, a mining excavator 1 is equipped with a boom 2, a stick 20, and a bucket 3 for gathering earthen material while digging. The bucket 3 includes a frame or shell 4 defining a cavity 16 for gathering material during the digging operation (FIG. 2). Shell 4 a pair of opposing sidewalls 14 joined by panel 10 defining bottom, rear and top surfaces of the cavity 16. The top wall 6 of the bucket includes supports 8 to attach the bucket to excavator 1. Multiple configurations of buckets and variations in bucket geometry exist for excavating buckets and other excavating machines could be used.

In the illustrated example, bucket 3 has a digging edge 5 (FIGS. 2-3 and 5). The digging edge 5 is that portion of the equipment that leads the contact with the ground and in an excavator bucket is generally formed by a lip and the front edges of the sidewalls. As seen in FIG. 2, shrouds 9 and teeth 15 are secured to the lip. Sidewalls 14 of a bucket 3 include wear parts, such as wing shrouds 9U. Teeth and/or shrouds are often secured to the digging edge 5 to protect the digging edge 5, break up the ground ahead of the bucket 3, and/or gather material into the bucket. Multiple teeth 7 and/or shrouds 9, such as disclosed in U.S. Pat. Nos. 9,222,243 and 10,612,214, which are each incorporated by reference in its entirety, may be attached to lip of bucket 3.

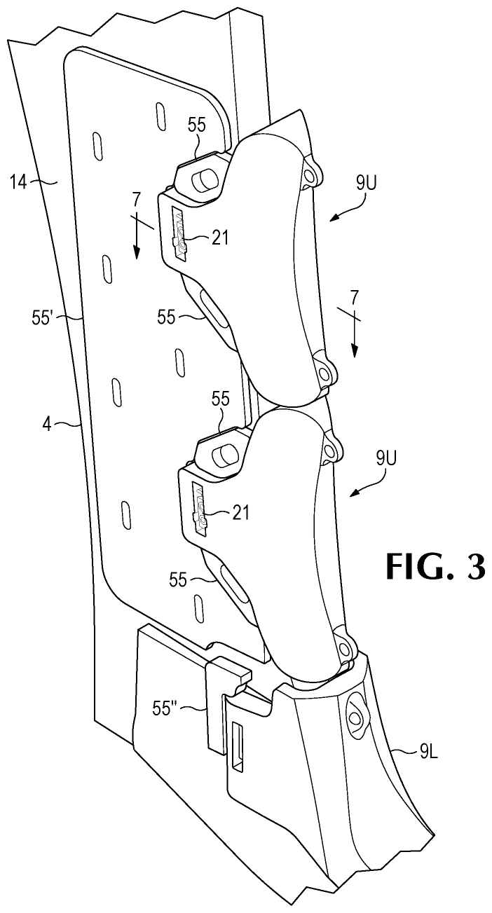

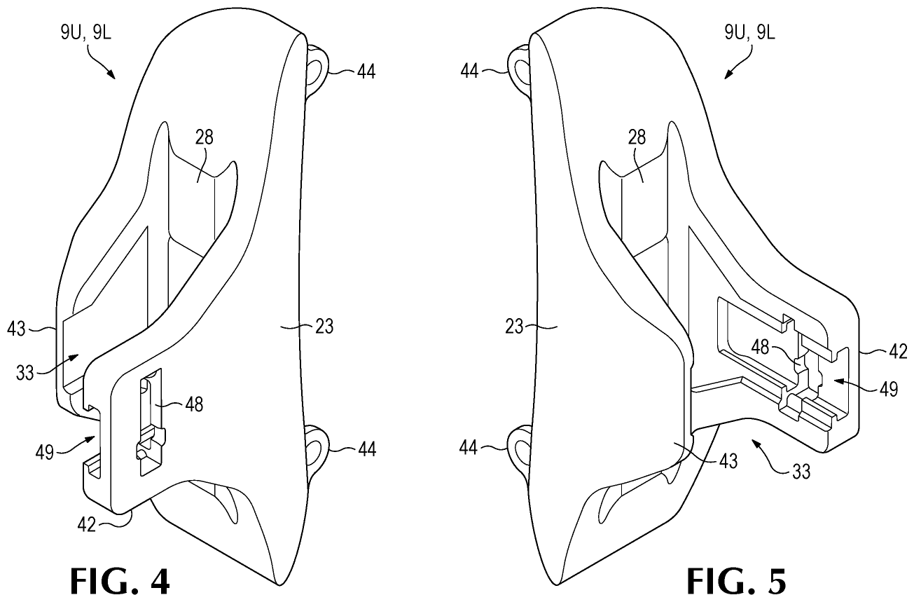

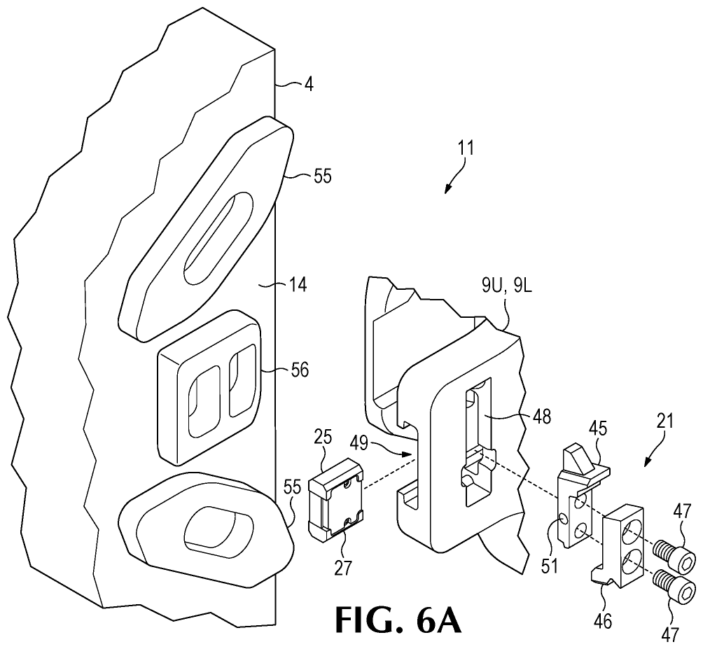

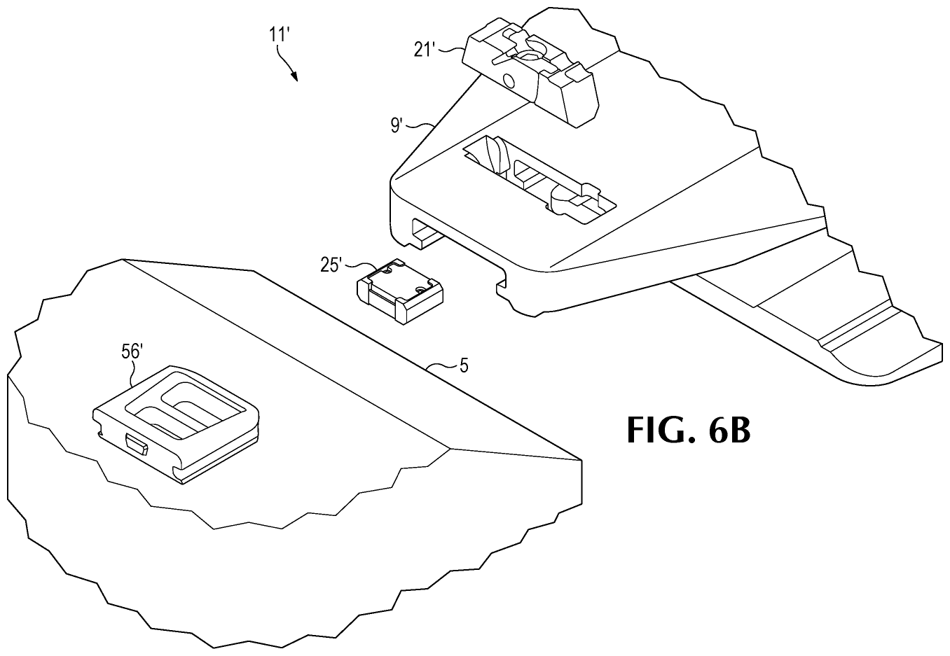

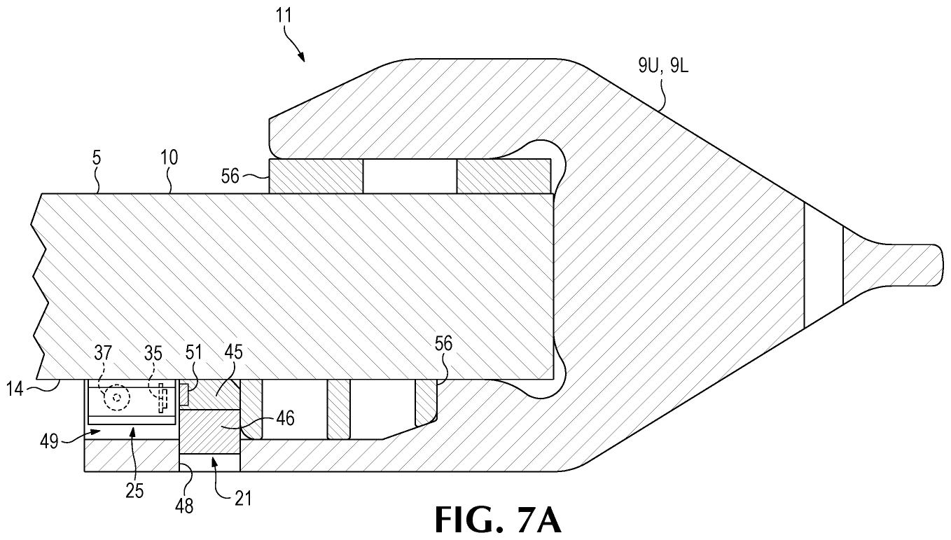

Referring to FIG. 3, two upper wing shrouds 9U and a lower wing shroud 9L are illustrated attached on the digging edge 5 but other arrangements are possible. Referring to FIGS. 4-5, the upper wing shroud 9U is illustrated as an exemplary example. The lower wing shroud 9L has a somewhat different configuration but is substantially similar with respect to the mounting and monitoring of the shroud. The wing shroud 9U includes an exterior surface 23 defined by a front and two sides and an interior surface 28 defining a cavity or channel 33. The channel 33 being sized and shaped to fit onto a digging edge of a bucket 3, and in this example the front edge of sidewalls 14. Situated on the exterior surface 23 may be lifting eyes 44 used to lift the wing shroud 9U for handling and during installation. The sides of the shroud 9U extend rearwardly into two arms 42, 43. The two arms 42, 43 further define the channel 33 as being a pass through channel between the arms 42, 43. In other examples, a single arm may be defined or the arms may have different lengths. Some wear parts (e.g., runners) could also have no arms but include a recess and opening for receiving a boss and lock. At least one of the arms 42, 43 (in this example, the arm 42 extending on the outside surface of the sidewalls 14) includes a lock opening 48 to situate a lock 21 therein. Arm 42 preferably includes a recess or opening 49 on an interior surface to receive a boss 56 fixed on the outside of the bucket sidewall (FIG. 6A), though in other examples each arm 42, 43 may include a recess for a boss. The recess 49 opens in the rear end of the arms 42, 43 to receive the boss during installation and communicates with the lock opening 48 so the lock and boss can interact to hold the wing shroud to the bucket. In one example, the lock opening 48 may be generally perpendicular to the boss recess 49. The boss 56 may be secured to the base by welding or mechanical attachment or cast as a component of the base (e.g. lip 5). Other kinds of lock openings 48 could be used.

Referring to FIGS. 6A & 7A, a shroud assembly 11 includes a wing shroud 9U mountable onto a digging edge 5, a monitoring system 27, and a lock (also called a retainer) 21. The shroud 9U is slid rearward onto the front edge of a sidewall 14 such that bosses 56 are received into recesses 49 of arms 42, 43 until the front end of channel 33 or a fit pad abuts against the front edge of the sidewall 14. In this installed position, the rear ends of the outside boss 56 (i.e., the boss interacting with the lock, which is the outside the sidewall in this example) will generally align with the front end of lock opening 48 so the lock 21 opposes or engages against the rear end of the boss when installed to hold the shroud to the bucket. The boss 56 and slot 49 could each have a corresponding T-shaped cross section with rails on the wear part and slots on the boss (as recess 49 is illustrated) or they each could have a planar sidewalls (as recess 56 is illustrated). Other kinds of sidewalls (e.g., dovetail) are also possible. The monitoring system 27 includes a monitoring device 25 secured to the base, which is this case is sidewall 14, and situated within a recess 49 adjacent the lock 21, and a remote device 38 situated away from the monitoring device 25. In this example, monitoring device 25 is positioned in longitudinal line with the boss 56 on an exterior side 14 and situated in recess 49 formed in the wing shroud 9U adjacent and rearward of the lock opening 48 when the wing shroud 9U is fit onto the digging edge 5. This is a beneficial location for the monitoring device because the recess already exists to receive the boss causing no detraction from the design of the wear part, the wear part shields the monitoring device from the earthen material and other hazards of digging, the monitoring device stays with the base and can be used with a plurality of successive wear parts, a strong, reliable signal can be transmitted at least partially through the rear opening of recess receiving the boss, and the monitoring device can be secured in place at various times including, e.g., in the field or during manufacture or set up of the bucket or lip). The monitoring device 25 includes one or more sensor 35, which may cooperate with or without a proximity device 51 or the like in and/or on the lock 21 (or shroud). The monitoring device may also include a battery, a communication device to send a wireless signal, and optionally other components. In the illustrated example, the proximity device 51 is located on a side surface of the lock 21. The lock 21 is used to secure the wing shroud 9U,9L to the base.

In the illustrated example, the shroud 9U fits over a boss 56 on each side of the base 5. The outside arm 42 optionally sets between two thrust blocks 55 on the exterior side 14 of the bucket 4. The thrust blocks 55 are situated above and below the wing shroud 9U, but other arrangements are possible. For example, wear plates 55′ are illustrated adjacent the shroud 9U (FIG. 3). In another example, a third thrust block 55″ may be situated adjacent the shroud 9L (FIG. 3). The thrust block 55″ and/or wear plates 55′ may prevent the shrouds 9, 9U, 9L from moving and at least partially seal the opening 49 at the rear of the shroud 9, 9U, 9L. This aids in protecting the monitoring device 25 from damage from the environment. The lock 21 holds the shroud 9U to the base 5 by engaging the boss 55 and the shroud 9U. The shroud assembly 11 could have a construction such as disclosed in, e.g., U.S. Pat. Nos. 5,088,214, 7,536,811 or 10,612,214, which are each incorporated herein by reference. Other constructions are also possible. The illustrated lock 21 includes first and second bodies 45, 46 and at least one bolt 47 to hold the bodies in position, though a wide variety of other kinds of locks could be used. The lock 21 is positioned into lock aperture 48 adjacent the boss 56 on one side and the monitoring device 25 on the opposite side. The lock 21 may or may not have a proximity device 51 (e.g., a magnet, RFID tag, etc.) to work with the monitoring device 25.

Wear parts can separate from a machine due to such things as impacts, high loads, fatigue, wear, breakage, etc. The lock may be lost resulting in separation of the wear part from the bucket, or the wear part may break or otherwise be separated from the bucket and thereby taking or ejecting the lock. When the ground engaging product becomes unexpectedly separated from the base, the ground engaging product is preferably replaced soon so production does not decrease and the base, upon which the ground engaging product is attached, does not experience premature wear. If the lock fails, the wear part will not ordinarily remain with the base during use of the earth working equipment. Accordingly, regardless of the reason for the separation, the lock ordinarily stays with the wear part (especially with locks integrally secured to the wear part) or is cast entirely out of the wear assembly due to the force on the wear part, breakage of the wear part, etc., when the wear part separates from an earth working machine. Since the lock is not retained with the base when the wear part separates from the equipment, the sensor on the base can detect the absence of the lock to identify that the wear part has separated from the base (or will soon separate if the lock has been lost). In any of these different circumstances, the monitoring device is able to monitor the presence and/or absence of the wear part even if the sensor is detecting the presence and/or absence of the lock.

The monitoring device 25 can also be used to determine if the base has separated from the earth working equipment, and thus also the wear part and lock associated with that base. In such a circumstance, the loss of a signal from the monitoring device 25 can identify that the base has separated from the earth working equipment.

Monitoring device 25 is secured to the base 14 and positioned in a boss recess 49 spaced from the boss in the shroud 9U, so as to be adjacent the lock 21 when the components of shroud assembly 11 are assembled together. In one example, the monitoring device 25 is secured to the base 14 prior to installation of shroud 9U so as to be received in opening 49 in wing shroud 9U when installed, i.e., in the rear portion of recess 49 not occupied by boss 56 or the lock 21, but in alignment thereof. In this position (i.e., in recess 49), the monitoring device 25 can be protected during the earth working operations, can provide reliable detection of characteristics of the wear part and/or base, and/or can be used to monitor successive wear parts secured to the base. By placing the monitoring device 25 on the base and in the boss recess 49, the components have a better chance of survival by not being in direct contact with the environment. The monitoring device 25 may be installed on the digging edge 5 as a part of the manufacturing process, in a shop and/or in the field. In addition, the monitoring device 25 may optionally be able to detect and/or provide other characteristics and/or information besides separation such as, e.g., high impacts, cycle times, temperatures, time in service, identity of wear part, etc. That is, the base (e.g., the digging edge) experiences similar impacts, cycle times, etc., during an earth working operation such as digging such that the information detected by the monitoring device secured to the based can be processed by a processor to determine the impacts, cycle times, etc. of the wear part secured to the base.

The monitoring device 25, when installed, may detect the presence and/or absence of the lock 21 (e.g., the body of the lock in the illustrated example) received in lock hole 48 when securing the wear part to the base or alternatively the presence and/or absence of the surrounding portion of the wear part or both the lock and wear part. The monitoring device 25 may also optionally monitor other characteristics of the wear part and/or base such as the usage, condition and/or performance of the wear part and/or base, and/or part identification such as disclosed in U.S. Pat. No. 10,011,975 or US Patent Application 2020/0378091, each incorporated herein by reference. The monitoring device 25 can also detect one or more of these other characteristics in addition to or instead of the presence and/or absence of the lock and/or wear part. The monitoring of separation as well as other characteristics can be accomplished in a number of different ways. For example, when absence of the lock is detected, the sensor can send a wireless signal to a remote device to alert the operator, maintenance personnel, manager, contractor, etc. that a wear part has separated from the machine.

In the illustrated example, the monitoring system 27 includes a proximity device 51 secured to (i.e., in and/or on) the lock 21 (and/or the wear part) and a sensor 35 in monitoring device 25 that can detect the presence of the proximity device 51. In the illustrated example, the proximity device 51 may be secured to or near the rearward side surface of body 45. The monitoring device 25 is received in recess 49 so as to be adjacent the rearward side of the lock 21, when the lock 21 secures the wear part to the base. The monitoring device 25 could alternatively be located in a hole offset but in communication with hole 49 so as to position monitoring device 25 adjacent a side of lock 21 (e.g., underneath the lock). This position may have the advantage of utilizing the spacing in-between the wear part and the base for communications while still being protected from the elements and digging environment. Other variations are possible for the illustrated lock 21, as well as, other kinds of locks that may be used. A proximity device could be secured to the wear part in addition or instead of the lock. Also, alternatively, the monitoring device may detect the presence and/or absence of the lock and/or wear part without a proximity device.

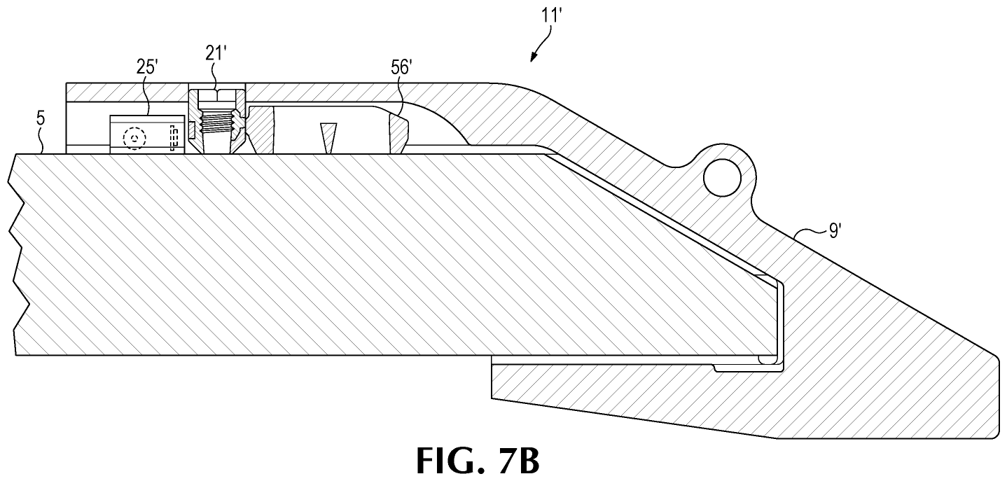

In one example, the proximity device 51 is a magnet, and the sensor 35 is a Hall effect sensor to detect the presence and/or absence of the magnet. The Hall effect sensor 35 generates a current and measures a change in the electric potential due to an introduced static magnetic field. The static magnetic field may be generated by a magnet 51 but can be generated by other means. The Hall effect sensor 35 acts as a switch when detecting changes in Hall voltage as affected by the presence and/or absence of the magnet 51 (e.g. changes in the electric field along a gradient, direction of electric field, etc.). If the magnet 51 is no longer in position to be detected by sensor 35, then this indicates that the lock 21 has become dislodged or lost, and that the wear part has separated from the machine. The sensor 35 may have a predetermined set value for either the electric field (V/M) and/or the magnetic field (mT). The predetermined set value determines how sensitive (e.g. loss versus pre-loss or dislodging) the sensor 35 is to a distance D the magnet 51 is away from the sensor 35 (FIG. 8). The predetermined set value may be static or dynamic. This kind of sensor 35 would not be as susceptible to damage through use such as from vibration or contact bounce as compared to a mechanical contact sensor. Such a sensor 35 can generally be used in severe conditions without being affected by environmental contaminants and costs less than a mechanical switch. The sensor 35 can measure a wide range of magnetic fields. In another example, the sensor 35 can count the number of hall effect indications as to count the quantity and timing of shroud changeouts.

In another example, the proximity device 51 is an RFID tag and/or other short-range detectable element c secured to the lock 21 (e.g., to a rearward side of a body of the lock 21). The RFID tag 51 is then detected by an RFID receiver sensor 35 (i.e., as part of the monitoring device 25) in hole 49 of the wing shroud 9U. When the wear part and lock separate from the base, sensor 35 loses signal with the RFID tag 51B. This loss of signal identifies that the wear part has separated from the base. In another example, the RFID receiver sensor 35 may keep track of each new RFID tag introduced so as to monitor inventory and replacement timing for the wear parts.

Other kinds of sensors could be used to detect the presence and/or absence of the lock in hole 49, and/or detect other characteristics of the ground-engaging product. For example, the sensors may include a temperature sensor, a digital inclinometer unit, a digital compass, an accelerometer, a timer, a proximity sensor, a position sensor, a hall effect sensor, a flux magnetometer, a magnetometer, a magnetoresistance sensor, an inductive sensor, RFID tag and/or reader, IR receiver, ultrasonic and/or other sensors that can detect the presence and/or absence of the lock securing the ground engaging product to the base and/or other characteristics of the wear part and/or base. Some sensors involve the use of a proximity device on the lock and/or wear part (e.g., an RFID tag, magnet, and the like) and some do not involve such use of a tag or other proximity device on the lock and/or wear part).

Although the use of a proximity sensor to detect a proximity device on the lock has been discussed above, other kinds of sensors could be used in lieu of or in addition to a proximity sensor. While monitoring devices that are free of moving parts are disclosed in various examples (e.g., Hall effect sensors), the monitoring device could include a sensor with a contact switch that contacts the lock or wear part and moves when the lock or wear part separates so as to identify the presence and/or absence of a lock and/or wear part. Monitoring devices free of such moving parts have less risk of failure due to accumulation of fines, damage caused by impacts, and the like. Monitoring devices free of such moving parts can also be encased and more securely protected by a body or filler material.

Monitoring device 25 can optionally include more than one sensor to increase the reliability of detecting the presence and/or absence of the lock and, hence, the presence and/or absence of the wear part mounted on the base. As one example only, monitoring device 25 can include a first sensor to sense a proximity device (e.g., a magnet, RFID tag and the like) on the lock as discussed above, and a second sensor to detect temperature changes. Continued digging with, e.g., a tooth after the wear part has separated will typically result in a temperature sensor in the base detecting a change in temperature. The monitoring device 25 could transmit a wireless signal when either sensor detects separation or only when both (or all if more than two are used) sensors detect separation or when some (if more than two sensors are provided) of the sensors detect separation. For example, the communication device may send a signal when the first sensor detects the wear part or lock is absent and/or when the second sensor detects that a threshold level temperature or change in temperature is reached. Also, a processor with programmable logic receiving the transmitted signals could assess the information received from the sensors (e.g., the amount of temperature change as compared to other similar GET components, the amount of time that has lapsed since receiving a signal regarding the proximity device, etc.) and make a determination as to whether the wear part has separated from the base.

Referring to FIGS. 6B & 7B, a shroud assembly 11′ mounts a shroud to the lip instead of the sides of the bucket (FIG. 6A). The shroud assembly 11′ includes a shroud 9′ fit over a boss 56′ on the inner side of the lip 5′ and locked into place by a lock 21′ that is monitored by a monitoring device 25′, but other arrangements are possible.

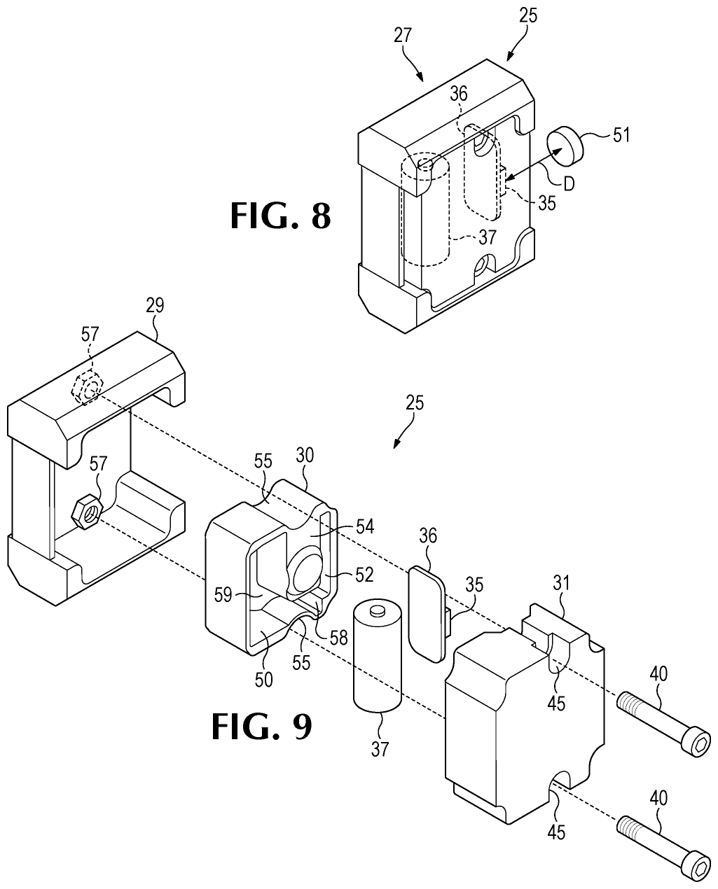

Referring to FIGS. 8-9, the illustrated monitoring system 27 includes a monitoring device 25 and a proximity device 51 (e.g., secured to the lock). The monitoring device 25 includes a housing 29, a sensor 35 to detect at least one characteristic of the wear assembly (e.g., the presence and/or absence of proximity device 51), a communication device 36 (e.g., a transmitter and/or receiver) for wirelessly communicating information (e.g., a signal indicating the wear part has separated from the machine) to and/or from a remote device 38 (FIG. 1) to receive the signal, and a battery 37. These can be different components working together or they may be combined on a printed circuit board (e.g., the sensor 35 and communication device 36 may be the same component). Monitoring devices 25 also could have other constructions and/or other components. For example, monitoring devices 25 can include multiple sensors for redundancy and/or sensing other characteristics (e.g., high impact events, digging cycles, etc.), storage mediums for holding data (e.g., the part ID, software, firmware, etc.), a GPS device, and/or a microprocessor for processing data or other information.

In one example, the electronics or components of monitoring device 25 are positioned in a housing 29. The housing 29 can aid in supporting the monitoring device components, positioning the sensor 35 relative to the lock, and/or providing protection for the monitoring device 25. The housing 29 may be situated to fit within the opening 49 and secured to the base 5, such that the outer surface of the housing 29 is within a close proximity to the lock (e.g. proximity being determined by the sensor's 35 detectable predetermined distance D). The monitoring device 25 may also be fit in opening 49 with or without contacting the walls of the opening 49; for example, a filler material may be included in and/or around housing 29 or left as open space. Preferably, the space between the monitoring device 25 and the interior of opening 49 is left vacant, but the interior may fill with debris/earthen material during use. The housing 29 could also be omitted. The housing 29, though, could be secured to the base 5 in many ways; for example, the housing 29 could be secured by weld, adhesive, fasteners, friction, supports, bolts, brackets, taper fit, friction, magnets and the like. In one example, the housing 29 may converge toward one end, such that the housing 29 converges generally in parallel with the inner surfaces of the recess 49 (e.g., 5°±0.5 degrees of convergence), but other configurations are possible.

More particularly, in the illustrated example, the sensor 35 and battery 37 are positioned into a sensor cup 30. The sensor cup 30 includes an opening 59 but it could have other forms. The opening 59 includes two compartments 50, 52 divided by a median wall 54 and a lower passage 58. The lower passage connects the two compartments 50, 52 and allows electronic equipment to pass between the two compartments 50, 52. The battery 37 is located in the first compartment 50 and the sensor 35 is located in the second compartment 52, though other arrangements are possible. The components 50, 52 of the monitoring device 25 can optionally be encased in a housing 29 and/or the hole 49 may be filled in with a filler material.

In one example, the compartments 50, 52 may be filled with a material that envelopes the sensor 35 and the battery 37 in the empty space of the opening 59, but it could be used to cover and/or fill less than these components and/or spaces. The material could protect the sensor 35 from water, fines, corrosive material and the like, and/or from impacts, strains and the like that may occur during use. The material may be a filler material in the form of resin, polymer, polyurethane, or other suitable material that plugs the opening 59. The material may be a dielectric material to improve transmission of the wireless signals. The material may be composed of elastomers, thermoplastics, thermosets, and/or other non-conductive materials. The filler material may optionally be made up of two (or more) different materials. Securing the components of the monitoring device 25 in a housing and/or body, and/or at least partially filling the hole 49 (i.e., outside of where the lock is received when securing the wear part to the base) with a suitable material may provide greater protection for the device 25 from water, fines, vibration, impact, etc. as the ground engaging product engages the material to be excavated or is otherwise worked. In another example, a trip bar and/or a thrust block 55′ can be used for guarding the open end of hole 49.

An outer cap 31 may be positioned over the sensor cup 30 and be mechanically secured to the housing 29, but other configurations are possible. In the illustrated example, the outer cap 31 is secured to the housing 29 by fasteners (e.g. bolts) 40. The outer cap 31 includes a groove 45 situated on at least one side. The groove 45 being sized and shaped for the fastener 40 to pass through and engage a nut 57. A similar groove 55 passes through the sensor cup 30.

The monitoring device 25 can be constructed to be removably secured to the base, though it could be permanently secured. Removably securing the monitoring device 25 allows the device 25 to be temporarily installed in the base, replaced when it breaks and/or when the battery is depleted, and/or removed at the end of life of the shroud 9. Installation to the base may permit successive use in multiple other wear parts.

Earth working equipment is commonly used in arduous environments where the survival of sensors is at risk. Having the monitoring device within a hole in the shroud or other wear part and secured to the base tends to provide improved protection for the components within the monitoring device 25 (e.g., a sensor(s) and a communication device) as compared to being mounted in the wear part or the lock because it can be sheltered by a combined assembly of, e.g., the wear part, the lock, and the base. Securing the monitoring device on the base as opposed to the wear part or the lock provides greater assurance the remote device 38 will receive the signal from the monitoring device 25 (i.e., indicating that the wear part has separated) will receive the signal, i.e., because the open space inside of hole 49 is less prone to signal blockage, thereby increasing the signal quality received by the remote device 38. In another example, when the wear part is lost, the monitoring device 25 is open to the environment and this may increase signal strength or quality. Another reason may be because if the monitoring device 25 is attached to the wear part, when the wear part is lost, the wear part or lock (if containing the sensor) could remain in the ground or be otherwise farther separated from the remote device when the wear part separates making it more likely the signal may not be received, i.e., increasing the risk of false readings.

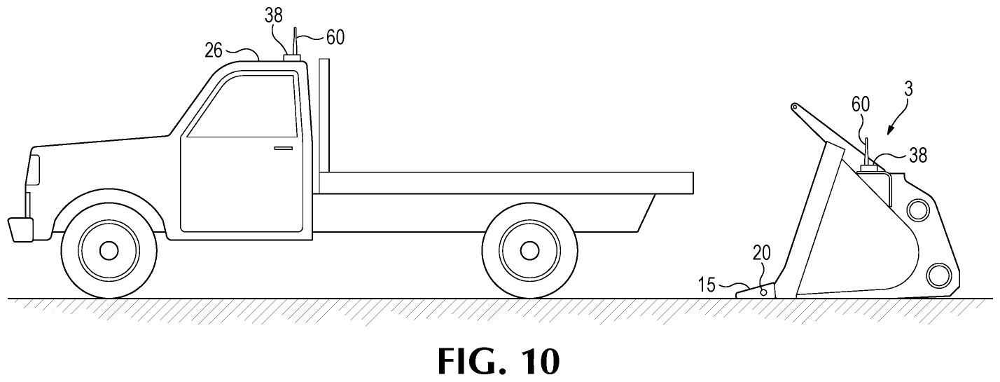

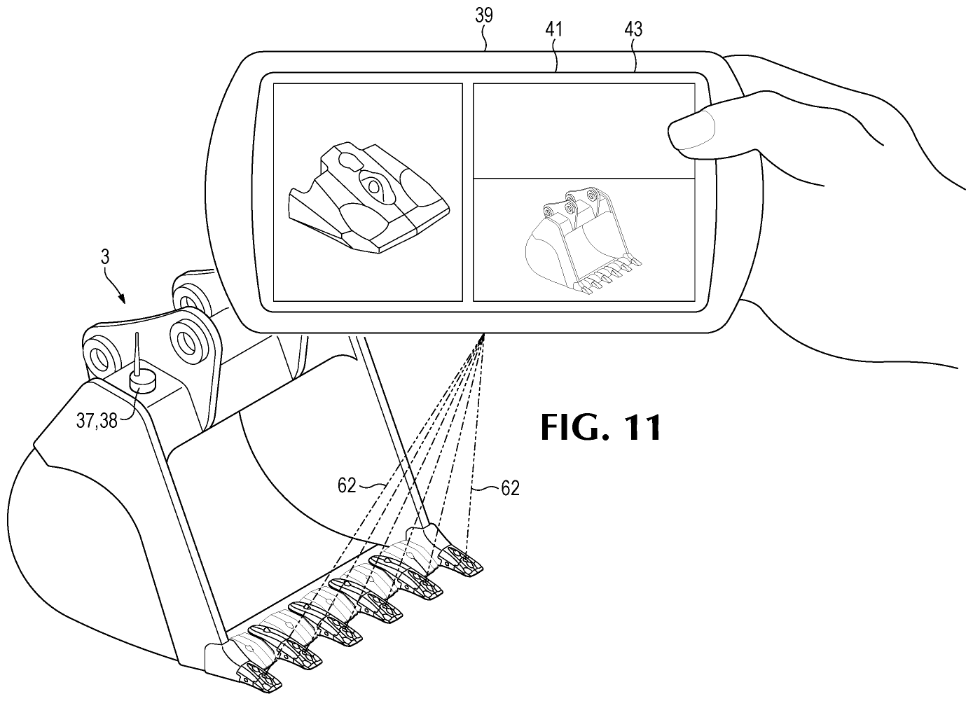

Monitoring device 25 (or any of the other examples) may communicate with a remote device 38, which herein refers to one or more device remote from the monitoring device 25. The remote device 38 can, for example, be secured to one or more of the bucket 3 (FIGS. 2, 10, and 11), the boom 2 (FIG. 1), the stick 20 (FIG. 1), the cab 24 of the digging machine 1 (FIG. 1), a service truck (FIG. 10), a drone, a handheld device 39 (FIG. 11), an augmented or virtual reality headset, etc. The remote device 38 can be a single component or a collection of components working together or separately. For example, a remote device 38 may include one or more of a processer 198 (PC, microprocessor, etc.), memory 200, a database 194, a transmitter, a receiver, a transceiver 60, etc. (FIG. 1). The remote device 38 may include one or more receivers (e.g., antennae) to receive the wireless signals 62 from the monitoring device(s) 25, a transmitter(s) to transmit signals, or a transceiver 60, a processor(s) to process information received from the monitoring device(s), a database(s) to store information, a human-machine interface(s), etc. The remote device 38 may communicate with additional sensors on the ground engaging product, other ground engaging products, other remote devices, multiple ground engaging products, earth working equipment 1 and/or with a database(s) and/or computer(s). The remote device 38, for example, may be a wireless device or a wired device. The term remote device 38 herein encompasses all such variations. Various examples may locate one or more components of the remote device 38 at predetermined points on the digging machine 1 and/or other vehicles 26 and pieces of equipment and/or in office space. Various examples may include mobile and handheld devices 39 as components of the remote device (FIG. 15). Examples may provide electronic canvassing of the sensors and/or communication devices to inventory the data collected. The data may be combined with previously known data and/or data collected from other locations. One or more programmable logic device may be utilized to manipulate the data into various machine usable and human usable formats, and/or to make various assessments.

The monitoring device 25 and/or remote device 38 may, for example, include a transceiver 60, for example, a radio frequency communication device, an electromagnetic wave receiver and/or transmitter, a mechanical wave receiver and/or transmitter, and/or Global Positioning System (GPS). The electromagnetic waves may have a wavelength outside of the visible spectrum (e.g., infrared, microwave, or Radio Frequency [RF]), and may be in the ultrasonic spectrum. As one example, the communication device could transmit a Bluetooth signal at 2.4 Gigahertz, but other means and other frequencies could be used.

The monitoring device 25 sends a wireless signal 62 regarding the detected characteristic(s) to the remote device 38 (FIG. 1). The signal 62 may, e.g., be continual, intermittent, batch, event driven, etc. In the illustrated example, the signal 62 is received by a transceiver 60 (e.g., an antenna) of remote device 38 mounted on the boom 2 of the excavator 1 (FIG. 1). An antenna 60 can be provided in other positions and/or mounted on different supports (e.g., on the bucket 3, near the cab 24, etc.) in lieu of or in addition to the antenna on the boom. The antenna 60 on the cab 24 in this example is shown wired 197 to a processor 198 having memory 200 in the cab 24 but could have a different connection or location. For example, an antenna 60 or other receiver could be mounted near the cab, on a service truck, on a handheld device 39, etc. The antenna 60 could be coupled to a wireless transmitter such that the information received from the monitoring device 25 and sent to the remote device 38 in the cab, may be provided to and/or combined with data from a handheld device 39, cloud database 194, other data sources, etc. to provide helpful information and/or analysis. Multiple antennas 60 could be used to increase the reliability of picking up the signal if desired or needed for the operation.

In cases where signals can only be received at certain times, monitoring device 25 and/or remote device 38 may transmit only during certain times (e.g., when the bucket is oriented in a particular way, when a trigger signal is received, etc.) or may continue to transmit continually. The monitoring device 25 may optionally transmit only when sensor detects the lock and/or wear part has separated from the base. Further, multiple remote devices and/or antennas could be used to receive information from the monitoring device continually or during longer periods even if the signal can only be accessed by the antenna on the boom 2 during certain intervals. A component of the remote device 38 may receive a signal 62 from a monitoring device 25 and relay the signal 62 to a second or third component of the remote device (FIG. 1). Any number of remote device components may be used to relay the signals as needed. The movement of the digging machine 1, including the individual articulated components thereof, and/or other vehicles at the worksite may tend to establish and reestablish the interrelationships of the sensors and communication devices. In this way, various and numerous communication paths may be established despite the great number of potentially shielding surfaces at the worksite.

In examples detecting separation, the loss of the lock 21 and/or the wear part, tends to lessen the signal blocking effects, which has the effect of increasing the likelihood of the remote device 38 receiving the signals from the monitoring device 25, which thus may increase the reliability of the system. The monitoring device 25 could operate only when the wear part separates, or it could operate continually. Continual operation provides the added benefit of ensuring the monitoring device is still operating and/or sensing other characteristics. A monitoring device may optionally increase the magnitude and/or speed of repetition of the signal it transmits when absence of the lock and/or wear part are detected so as to increase the likelihood the remote device 38 receives the signal indicating the wear part has separated from the base. Increasing the likelihood, the remote device receives the signal can improve the reliability of the monitoring system. As a lost wear part could be without a tracking device, the location of the wear part may be unknown upon separation. In such situations, the advantage of receiving the identifying signal upon separation increases the likelihood of locating the lost wear part. The monitoring device 25 may optionally include additional sensors (e.g., one or more of a GPS, accelerometer, inclinometer, etc.), which can determine the path of the last digging cycle or bucket payload to determine the area of where the lost wear part may be found. Other tags, sensors, etc. could also optionally be included in the wear part (e.g., as disclosed in U.S. Pat. No. 10,011,975).

The remote device 38 and/or the monitoring device 25 may on their own, collectively, and/or with other devices, and/or software applications, and the like (e.g., data 200 from a database 194 in, for example, a cloud database, other processors, etc.), store, process and/or communicate information or data 200 related to a characteristic of the wear part. Monitoring device 25 may along with detecting separation also optionally (or in lieu of detecting separation) include one or more sensors for identifying other characteristics of the wear assembly besides separation of the wear part including, for example, part ID, usage, temperature, acceleration, inclination, etc. of a ground engaging product such as tooth 7, shroud 9 or other wear assembly for earth working equipment. (FIG. 1). Information related to the part ID can include such things as ground engaging product type, part number, customer, brand name, trademark, manufacturer, bill of materials, etc. The part ID may be used as search criteria in order to retrieve additional information regarding the specific ground engaging product. The search criteria may be used to query one or more relational databases and/or broader data structures. Information related to usage can include such things as the kind of machine to which the ground engaging product is secured, time the ground engaging product went into service, how many digging cycles the ground engaging product has experienced, average time of the digging cycles, location of the ground engaging product on the machine, impact events, etc. These monitored characteristics are given as examples only and are not intended to be limiting. Information may be shared with, i.e., sent to and/or received from, various other machines including programmable logic, monitoring devices, remote devices, other networks, and used with various software applications, and routines.

The monitoring device 25 and/or remote device 38 can use programmable logic to process information generated from, e.g., monitoring device(s) 25 and/or the remote device(s) 38 for monitoring characteristics such as the part ID, presence, condition, performance, and/or usage of the ground engaging product being monitored and/or providing alerts to the operator. Processors (e.g., microprocessors), using programmable logic may be part of monitoring device 25 and/or a remote device 38. The programmable logic included in a remote device 38 may, for example, use information received from monitoring device 25 to identify that the ground engaging product is still secured to the base. When the ground engaging product has unexpectedly been separated from the base, the monitoring device 25 may send an alert signal indicating a change in the condition of the ground-engaging product. In another example, the processor may use information about the geology of the mine site in combination with usage information from monitoring device 25 to determine, e.g., the estimated wear life remaining for the ground engaging product. For example, the programmable logic may use the number of digging cycles and/or the duration that a ground engaging product has been in service to determine the estimated wear life remaining. The programmable logic may be programed to produce a precautionary alert that a specific ground engaging product is close to needing replacement. The alert may be, for example, a visual alert, haptic feedback, and/or an audio alert. The devices 25 and/or 38 may provide the alerts to devices for access by the operator or others such as maintenance personnel, mine site managers, or the like. In addition, the programmable logic may be programed to produce an alert if the condition indicates, e.g., that the ground engaging product has been unexpectedly separated from the base.

In one implementation, the results and alerts from the process may be sent to at least one Human-Machine Interface (HMI) 41. The HMI could, e.g., be a handheld device 39 as shown in FIG. 11, mounted in a cab of a vehicle such as a digging machine or haul truck, or in an on-site or off-site location. The features, events, data or the like detected by the monitoring device can be processed with other collected or stored data by programmable logic to determine a wide variety of factors that may influence the machine operator. The system may make determinations by including outside factors such as the hardness or abrasiveness of the earthen material being worked, the material composition of the ground engaging product being monitored, etc. Also, as discussed earlier, the system may be coordinated with a ground-engaging inventory and supply system. The system may also be coordinated with other kinds of information such as scheduled maintenance to determine the most efficient time to replace or maintain the ground engaging product being monitored. In turn, the HMI 41 can on the basis of the detected features and/or processed information provide alerts, data, expected wear lives, and the like for more efficient use of the earth working equipment.

The HMI 41 may be hard wired or may be a wireless device, may be integrated with a display system currently in the excavating equipment (e.g., with the OEM display), integrated with a new display system within the excavating equipment, and/or may be in a remote location. The HMI 41 may be configured to provide a graphical display of the current condition of the ground engaging product. The HMI 41 may, for example, provide visual alerts (e.g., text and/or pictorial images), haptic feedback (e.g., vibrations), and/or audio alerts regarding each ground engaging product. The visual alert may be, for example, a graphical picture displaying each ground engaging product and the condition of each ground engaging product (i.e., absent/present, needing maintenance, etc.). The HMI 41 may be designed to display a history chart so that an operator can determine when an alert happened so that an operator can take the necessary actions if a ground engaging product is unexpectedly separated. The HMI 41 may include a display 43. The display 43 may include various visual indicators including but not limited to: photographs or real time images of, for example, similar ground engaging products from a database; photographs taken with camera at the worksite, such as with camera 190 on boom 2 (FIG. 1); remaining wear life; bucket configuration; etc.

In one example, a camera could be attached to, e.g., the bucket 3, the boom 2, the stick 20, the machine 1, drone, service truck 26, or other support to provide a visual double check for the operator. In the illustrated example, a camera 190 is secured to the boom 2 to capture (at least part of the time) a visual image of the ground engaging products attached to the bucket 3. When the machine display (or another) receives an alert that, e.g., a ground engaging product has separated, a display showing the visual image within the cab can be checked to ensure the noted ground engaging product is actually missing from the bucket. The checking may use computer vision, augmented reality, virtual reality, and the like which has been programmed to look for ground engaging products in a specific location. This backup system can reduce false alarms that cause the operator to stop operation of the machine.

In another example, systems involving cameras such as used in prior art systems or as disclosed in U.S. Patent Application 2016/0237640, which is incorporated by reference in its entirety, can be used in combination with the monitoring systems described in this application. The information received from the camera-based systems can be used as a backup double check to reduce the number of false alarms. Alternatively, the monitoring devices 25 disclosed herein could be a backup double check for the camera-based monitoring systems. Further, the data collected by both a camera-based monitoring system and a non-camera based monitoring system (such as disclosed herein) could be collectively processed to determine, e.g., the part ID, presence, usage, condition and/or performance of the ground engaging product. The full data received by both systems could lead to more reliable conclusions and assessments. The performance of the ground engaging product could be related to the number of digging cycles and/or the length of said digging cycles. Digging cycles may be measured from the time of impact with the ground to the next impact with the ground. Digging cycles may also be measured as operational cycles, which is the amount of time required to fill a load container.

The monitoring device 25 may also communicate with other computer systems, wirelessly or through a cable, the specific ground engaging product(s) needing maintenance either because the ground engaging product is separated or because there is an indication that the ground engaging product may need maintenance. The monitoring device may store all the results from the process.

The above disclosure describes specific examples ground engaging products and systems for identifying characteristics such as the part ID, usage and/or presence of a ground engaging product used on earth working equipment. The features in one example can be used with features of another example. The examples given, and the combination of features disclosed are not intended to be limiting in the sense that they must be used together.

1. A monitoring system for earth working equipment, the monitoring system comprising:
a base of the earth working equipment, the base including at least one side over which earthen material passes during use of the earth working equipment, and a boss on the at least one side;
a wear part on the base, the wear part including a recess to receive the boss;
a lock securing the wear part to the base; and
a monitoring device secured to at least one side of the base in the recess between the wear part and the base and spaced from the boss, the monitoring device including at least one sensor to monitor at least one characteristic of the wear part and a communication device to send a wireless signal regarding the at least one characteristic to a remote device.

2. The monitoring system of claim 1 wherein the wear part includes a pair of spaced arms defining a mounting cavity for receiving the base.

3. The monitoring system of claim 1 including a proximity device secured to the wear part and/or the lock, wherein the monitoring device detects the presence and/or absence of the proximity device.

4. The monitoring system of claim 3 wherein the proximity device is a magnet.

5. The monitoring system of claim 3 wherein the proximity device is an RFID tag.

6. The monitoring system of claim 1 wherein the wear part is an adapter.

7. The monitoring system of claim 1 wherein the wear part is a shroud.

8. The monitoring system of claim 1 wherein the at least one characteristic of the wear part monitored by the monitoring device includes an identification, condition, usage, presence and/or performance of the wear part.

9. The monitoring system of claim 1 wherein the monitoring device monitors the presence and/or absence of the wear part on the base.

10. The monitoring system of claim 1 including a remote device to receive a wireless signal from the monitoring device pertaining to the monitored at least one characteristic of the wear part.

11. The monitoring system of claim 10 wherein the remote device includes a processor to process the information received from the monitoring device.

12. A monitoring system for earth working equipment, the monitoring system comprising:
a wear part including a mounting cavity to receive a base, a recess open to the mounting cavity to receive a boss on the base, and a lock opening that opens in the recess;
a lock in the lock opening and in the recess adjacent the boss to secure the wear part to the base; and
a monitoring device received in the recess and secured to a side of the base and spaced from the boss to monitor at least one characteristic of the wear part.

13. The monitoring system of claim 12 wherein the monitored at least one characteristic is the presence and/or absence of the wear part on the base.

14. The monitoring system of claim 12 wherein the monitoring device detects the presence and/or absence of the lock and/or the wear part.

15. The monitoring system of claim 12 wherein the wear part includes a pair of spaced arms defining a mounting cavity for receiving the base.

16. The monitoring system of claim 12 including a proximity device secured to the wear part and/or the lock, wherein the monitoring device detects the presence and/or absence of the proximity device.

17. The monitoring system of claim 12 wherein the at least one characteristic of the wear part monitored by the monitoring device includes an identification, condition, usage, presence and/or performance of the wear part.

18. A monitoring system for earth working equipment, the monitoring system comprising:
a base secured to the earth working equipment and including a boss;
a wear part including at least one arm having a recess to receive the boss and a lock opening that communicates with the recess;
a lock received in the lock opening in the wear part to secure the wear part to the base; and
a monitoring device secured to the base and received in the recess adjacent the lock and spaced from the base, the monitoring device detecting the presence and/or absence of the lock and/or the wear part, and wirelessly transmitting a signal to indicate when the lock and/or the wear part is absent from the base.

19. The monitoring device of claim 18 including a proximity device located on the lock and/or the wear part, wherein the monitoring device detects the presence and/or absence of the proximity device.
